(19) United States
(12) Patent Application Publication
(10) Pub. No.: US 2013/0067542 A1
(43) Pub. Date: Mar. 14, 2013

(54) Connection authorization with a privileged access

(71) Applicants: Deepak Gonsalves, Bridgewater, NJ (US); Calvin Charles, Piscataway, NJ (US); Deepa Jagannatha, Somerset, NJ (US); Ramesh Parmer, Scotch Plains, NJ (US); Byung Joon Oh, Piscataway, NJ (US); Subramanyam Ayyalasomayajula, Kendall Park, NJ (US)

(72) Inventors: Deepak Gonsalves, Bridgewater, NJ (US); Calvin Charles, Piscataway, NJ (US); Deepa Jagannatha, Somerset, NJ (US); Ramesh Parmer, Scotch Plains, NJ (US); Byung Joon Oh, Piscataway, NJ (US); Subramanyam Ayyalasomayajula, Kendall Park, NJ (US)

(21) Appl. No.: 13/606,129

(22) Filed: Sep. 7, 2012

Related U.S. Application Data
(60) Provisional application No. 61/532,970, filed on Sep. 9, 2011.

(51) Int. Cl. G06F 21/20

(52) U.S. Cl. 726/4

(57) ABSTRACT

Disclosed is a connection authorization method with an access privilege transferring algorithm for safely transmitting privilege information between virtual mobile management tool and communication endpoint gateway (CEG) server through embedded stub. Secret Shared Key (SSK) information is shared between the embedded stub and communication endpoint gateway server (namely, session mediation server) through VMM (Virtual Mobile Management) client. A stub that generates access privilege information transfers access privilege information to VMM tool. The stub applies a two-way communication channel between the session mediation server and the VMM tool by joining the generated privilege information and the SSK information to each other, thereby generating protected privilege information with which a third party or hacker who does not know the secret information is not capable of interfering. Exploiting the protected privilege information makes it possible to safely connect authorization with access privileges.

### CROSS-REFERENCE TO RELATED APPLICATION

This application is related to U.S. patent application Ser. No. 12/550,742, filed on Aug. 31, 2009, and claims the priority date of U.S. Provisional Patent Application No. 61/532,970, filed Sep. 9, 2011, and entitled “Connection Authorization with a Privileged Access”, the contents of which is incorporated herein by reference.

### FIELD OF INVENTION

The present invention relates to a connection authorization transferring method through an access privilege for safely connection between users over live wireless networks.

### BACKGROUND OF THE INVENTION

With rapid advances in a recent Information Technology (IT) field as well as telecommunications, numerous distributed computer systems such as smartphones, tablet, etc. have been developed and manufactured and are now widely used in laboratories of universities, etc., enterprises' offices, homes, everywhere. Digitized countless source objects such as a text format, a document file, a voice file, an image/video file can be controlled over a wireless computer system.

In recent years, under a ubiquitous computing environment, most of smart phones/tablets have been connected to networks such as a WLAN/LAN, an Internet and placed. It is not obligatory for respective users to distinguish the places of resource objects such as programs, data in particular under the scattered computing environment. Furthermore, in distributed form over the network, procedures and methods implemented by smartphones have been held and coped.

An interface for the executed procedure is pronounced in advance and placed in both computers on request and execution sides, whereby such remote formula call can be appropriately executed. Moreover, a secure computer/mobile devices environment by governing access to data and processes on a data processing system through Mandatory Access Control (MAC) is provided by Multi-Level Security (MLS), also known as labeled security. A mechanism that allows objects and subjects to be marked with labels, such as unclassified, classified, secret, and to secret is MAC. Hence, within a single operating environment by labeling data and processes with privilege labels, multi-level security enables data to be separated into different sensitivities. In defense sectors, governments sectors, and financial organizations, such as banks, this type of classification is of great importance.

It is essential to distinct various administrative functions into most OS environment to appropriately manage a secure computer/mobile devices system in an MLS environment, by a single user ID, generally referred to as a “super-user” or “root user”, system administration permits all privileges and connection authorizations to be controlled and planned.

Nonetheless, the default system administration roles are the information system security officer, the system administrator, and the system operator in a role-based access control multi-level system environment. In a role-based access control system, each of the roles possess certain privileges and authorizations assigned to them which permit the mobile users with these roles to complete certain privileged programs or processes, and access privileged data. When a remote control session is set-up, certain normal privileges are assigned to a specific user automatically.

Based on a user invitation for access to the program, process, or data, other privileges are commonly assigned or granted obviously. The sessions of users with authorized roles are assigned or granted privileges only by the approved person. To grant privileges to other roles or entities, no other role or entity has the capability. The set of privileges granted to an entity can embrace, but is not limited to, login, read-only, write-only, read and write, file-system access, mandatory access control, input/output (I/O), discretionary access control, and etc.

For the stability of a computer or mobile devices system which can lead to the loss of data and system integrity, actions by malevolent users have serious complications. Furthermore, without alerting other administrative roles or entities defeats the purpose of multi-level labeled security, the employment of super user authorizations by a malicious user to grant privileges to the malicious user.

Wireless handhelds are increasingly becoming more powerful and multi-functional with advancements in hardware and operating systems components, thus providing application developers a common set of programming interfaces or APIs to create rich interactive applications. These applications are either pre-installed prior to commercial shipment or downloaded over-the-air by the customer. Due to the varied complexity of these “smart” device and the applications that execute within them, customer seeks operator's support to troubleshoot their devices.

The customer care organization may require troubleshooting software to provide effective customer support.

It may be advantageous to provide an apparatus that provides remote control and diagnostic capabilities to the customer care for effective troubleshooting.

As a result, this invention especially covers that wireless handheld devices typically communicate with each other over commonly defined standards based wireless protocols. These devices are typically untethered, unlike wired communication devices such as telephones. Wireless operators provide the wireless networking infrastructure and provide service to the end customer. The customer subscribes for such a service from the operators who in turn guarantee a certain degree of quality of service to their customers.

### OBJECTIVES OF THE INVENTION

Disclosed is a connection authorization method with an access privilege transferring algorithm for safely transmitting privilege information between virtual mobile management tool and communication endpoint gateway (CEG) server through embedded stub. Secret Shared Key (SSK) information is shared between the embedded stub and communication endpoint gateway server namely, a session mediation server, through Virtual Mobile Management (VMM) client. A stub that generates access privilege information transfers access privilege information to VMM tool. The stub applies a two-way communication channel between the session mediation server and the VMM tool by joining the generated privilege information and the SSK information to each other, thereby generating protected privilege information with which a third party or hacker who does not know the secret information is not capable of interfering. Exploiting the protected privilege information makes it possible to safely connect authorization with access privileges.

It is, therefore, an objective of this invention to provide an improved method and apparatus for connection authorization with a privileged access of the VMM that overcomes the foregoing and other problems.

Another objective of this invention is to provide a secure way of authorizing connections from a known source to perform Virtual Mobile Management.

Another objective of this invention is to disclose the use of an embedded stub that uses a secured key exchange procedure to mutually authenticate with the VMM tool before granting the privileged access to the system level Application Programming Interface (API) thereby reducing the security threat.

Another objective of this invention is to disclose a method of elevating the access privilege to VMM tools only and hence no other applications are granted root access.

Another objective of this invention is to offer a method and apparatus for a secured way of authorizing connection using embedded stub inside mobile device.

Another objective of this invention is to deliver a method and apparatus for overcoming security risk using a secured key exchange procedure.

Still another objective of the invention is to provide under a ubiquitous computing environment in which a plural mobile devices are connected to one another by a network and they are distributed over the 3G/4G/Wi-Fi networking wherein a method provides a connection authorization manner with an access privilege transferring method for safely transferring data streaming including access privileges between mobile device users and session mediation server.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic overview of System Architecture;

FIG. 2 is a pictorial illustration of communication between Mobile Client and CEG Server; and

FIG. 3 is a schematic of a Call Flow between session mediation server and VMM tool procedure.

### DETAILED DESCRIPTION OF THE INVENTION

Mobile device's OS operated by Mobile OS's kernel such as Linux, Darwin, Window CE, and the like utilizes the Mobile OS' security policies. What is needed is elevated privileges which can be accessed by the super user “su” (root) context for accessing certain Application Programming Interface (API)'s in mobile device's OS. Due to security threats, applications with “root” privilege are limited by mobile device's OS. By giving way for any other harmful application to run with the “root” privileges, to allow only a specific application to operate under “root” without super user (root) privilege will prevent the risk of giving provisional super user access.

While the current user is not the “super user”, kernel of Mobile OS permits leveraging an application as “root”. This is accomplished by adapting the SUID file permission bit of an application. Every file or folders in mobile OS possess the access permissions. There are three types of permissions: read access, write access, and execute access. Permissions are defined for three types of users: the owner of the file, the group that the owner belongs to, and other users.

In addition to the basic permissions discussed above, there are also three bits of information defined for files in the kernel of Mobile OS: SUID—Set User ID; SGID—Set Group ID; and STICKY—Stick in memory. SUID stands for Set User ID. When a SUID file executed, the process which runs it is granted access to system resources based on the user who owns the file and not the user who created the process. When a file is SUID root it allows a program/script to perform functions that regular users are not allowed doing themselves.

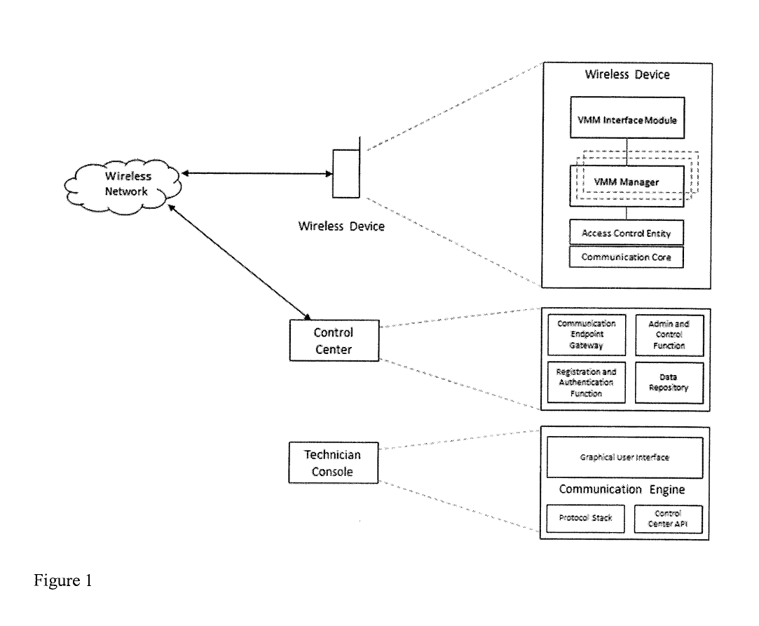

Now referring to FIG. 1, set forth is a schematic diagram illustration of overall system architecture about data flow connections from a wireless mobile device via the communication endpoint gatewayserver (session mediation server) and Admin and Control server as Control center as well as Technician Console.

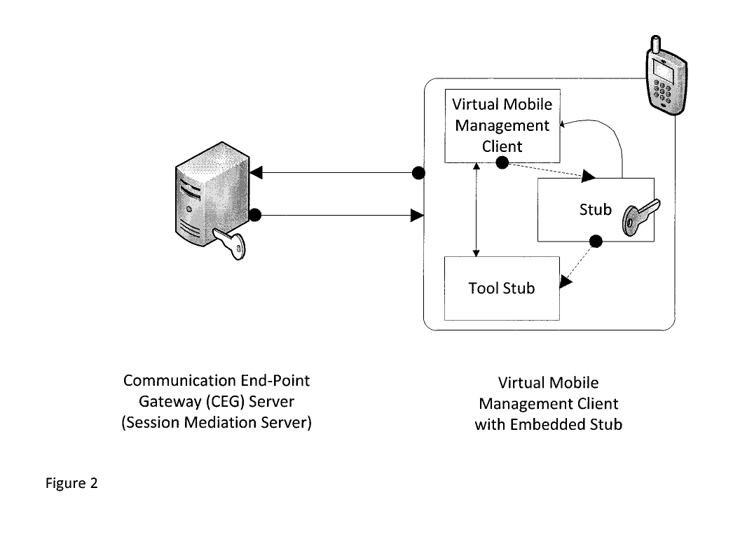

FIG. 2 illustrates the communication link between mobile device and session mediation server which system composes a session mediation server and a mobile device with the embedded client stub including VMM client/tool. Hence, the current invention describes the method of elevating the access rights of an application to invoke a secure connection in mobile OS based mobile devices.

Virtual Mobile Management client for mobile devices' OS consists of different tools for performing device remote control, system diagnostics, health monitoring, etc. These tools can be remotely installed over-the-air. Few of these tools require root privilege to access certain system API. The embedded client is a stub that elevates the access privilege of the tool to access some system level API on the devices to perform remote VMM. The embedded stub is integrated with the mobile device's OS with “root” as the owner with the SUID bit set. Any application which invokes the embedded stub to request for executing an application with the elevated privilege has to undergo secure handshake through Session Mediation Server. To run an application as root the application has to be invoked by the “super user” or it has to be invoked by an application that is running as “root”.

Secured Privileged Access to the Embedded Client: The stub is embedded into the mobile device by the device vendor with “root” privilege. The next step is to install the Virtual Mobile Managementclient and tools on the mobile device. When the Session Mediation Server makes a connection to the device the Virtual Mobile Management Client does not have the right privilege to invoke any of the installed tools. Hence the stub gets invoked by the client. The stub then elevates the access level of the Tool Stub to make the connection. When the stub receives a connection request from the Mediation server for the first time after installation a Key Exchange procedure for mutual authentication takes place between the stub, Virtual Mobile Management Client and the Session Mediation Server. The Session Mediation server and the embedded stub communicate through a secure link via Virtual Mobile Management Client.

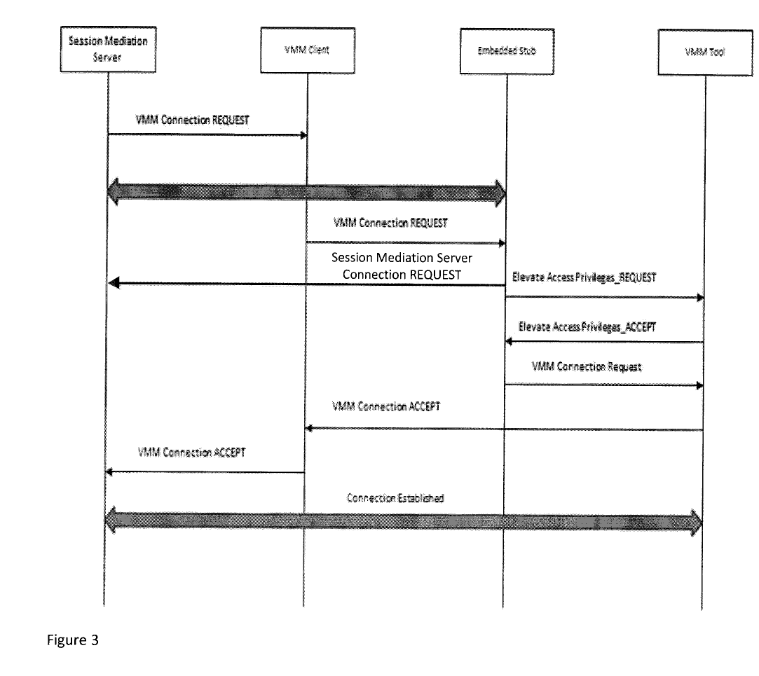

FIG. 3 is a timing-sequence diagram illustrating the establishment of a call flow between a mobile device (VMM tool) and a session mediation server according to this invention. In this invention, SetUID on Executable and Public-Key Cryptography (Shared Secret Key) are utilized to make a connection between the session mediation server and VMM tool.

1. The Session Mediation Server sends a “Connection Request” to the Mobile Device for Virtual Mobile Management.

2. VMM Client on the mobile device cannot invoke the VMM tool to complete the Connection Request as it does not have the privileges.

3. VMM Client sends the Connection Request message to the Embedded Stub on the mobile device.

4. The Embedded Stub is integrated with the mobiledevice's OS with “root” as the owner with the SUID bit set.

5. Stub establishes connection with VMM client which has a pre-established connection with the session mediation server.

6. The Stub elevates the access level privilege of the VMM tool and forwards the Connection Request.

7. The VMM Tool receives the Connection Request and sends a response to the VMM Client.

8. The VMM tool can now access the system level API on the mobile device's OS to perform the VMM.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for providing a secured connection for a mobile device comprising:
embedding a stub that generates access privilege information into the mobile device by a device vendor;
installing a Virtual Mobile Management (VMM) client and VMM tools on the mobile device.
detecting when a session mediation server makes a connection request to the mobile device and determining if the VMM client has privileges to allow access to invoke the installed tools;
elevating access level of said embedded stub for detecting a connection request from the session mediation server; and
initiating a Key Exchange procedure for mutual authentication between said embedded stub, VMM Client and the session mediation server;
wherein the session mediation server and said embedded stub communicate through a secure link via the VMM Client.

2. The method for providing a secured connection for a mobile device according to claim 1 wherein said embedded stub exchanges a key algorithm with the VMM tool to enable the VMM tool to connect with the session mediation server.

3. The method for providing a secured connection for a mobile device according to claim 1 wherein said embedded stub provides accelerated access level privilege between the session mediation server and the VMM tool.

4. The method for providing a secured connection for a mobile device according to claim 1 wherein the VMM tools are selected from the group of: performing device remote control, system diagnostics, and health monitoring.

5. The method for providing a secured connection for a mobile device according to claim 1 wherein the VMM tools are wirelessly installed from a remote location.

6. The method for providing a secured connection for a mobile device according to claim 1 wherein said embedded stub is integrated with the mobile device's operating system with “root” as the owner with the SUID bit set.

7. The method for providing a secured connection for a mobile device according to claim 1 wherein said embedded stub elevates the access privilege of the tool to access some system level application programming interface (API) on the mobile devices to perform remote VMM.

8. The method for providing a secured connection for a mobile device according to claim 1 wherein the VMM client has a pre-established connection with the session mediation server.

9. The method for providing a secured connection for a mobile device according to claim 1 wherein secret shared key information is shared between said embedded stub and the session mediation server through the VMM client.

10. The method for providing a secured connection for a mobile device according to claim 9 wherein the session mediation server is a communication endpoint gateway server.

11. The method for providing a secured connection for a mobile device according to claim 1 wherein said embedded stub applies a two-way communication channel between the session mediation server and the VMM tool by joining generated privilege information and secret shared key information to each other generating protected privilege information.
